(19) United States
(12) Patent Application Publication
(10) Pub. No.: US 2026/0085890 A1
(43) Pub. Date: Mar. 26, 2026

(54) CALCINATION VESSEL FOR MANUFACTURING ELECTRODE ACTIVE MATERIAL

(71) Applicant: L&F CO., LTD., Daegu (KR)

(72) Inventors: Cheong Soo CHOI, Daegu (KR); Ji Woo OH, Daegu (KR); Sang Gyu CHOI, Daegu (KR); Sol Yi GAL, Daegu (KR); Jin Hyeon LIM, Daegu (KR); Jae Hak JEONG, Daegu (KR)

(21) Appl. No.: 19/106,697

(22) PCT Filed: Sep. 4, 2023
(86) PCT No.: PCT/KR2023/013187

§ 371 Date: Feb. 26, 2025

(30) Foreign Application Priority Data
Sep. 7, 2022 (KR) 10-2022-0113500
Mar. 23, 2023 (KR) 10-2023-0038073

(51) Int. Cl. F27B 9/24; F27D 3/00; F27D 5/00

(52) U.S. Cl. CPC F27B 9/2469; F27D 3/00; F27D 5/0068; F27D 2003/0013; F27D 2003/0042; F27M 2003/03

(57) ABSTRACT

Disclosed is a calcination vessel for manufacturing electrode active materials, the calcination vessel including a base portion forming a bottom surface of the calcination vessel, side wall portions extending upward from outer peripheries of the base portion to form a raw material receiving space, and at least one stack support portion extending upward from a part of an upper end of each side wall portion that is not a corner region where adjacent side wall portions abut each other.

### TECHNICAL FIELD

The present invention relates to a calcination vessel for manufacturing electrode active materials capable of improving the flow of a fluid when a plurality of calcination vessels is horizontally disposed and stacked in multiple layers, thereby increasing reactivity of an active material, and compensating for the structural weakness of a side wall portion, thereby firmly supporting the high load applied to the side wall portion of each of the calcination vessels stacked in multiple layers, and therefore it is possible to improve productivity and stability.

Part of the present invention is the result of research conducted with support from the Daegu Metropolitan City Next Generation Battery-Focused Energy Company Support Project.

### BACKGROUND ART

A calcination process is essential for the manufacture of electrode active materials such as positive electrode active materials. A roller hearth kiln (RHK) calcination method, which is a representative method of calcining electrode active materials, is widely known in the art to which the present invention pertains, and is used for mass production of products on industrial sites.

The RHK calcination method includes mixing a powdered lithium raw material and a metal raw material, placing the mixture in a calcination vessel, introducing the calcination vessel into a horizontal furnace with temperature settings for each zone, and performing continuous calcination while moving the calcination vessel several tens of meters along a conveyor.

The lithium raw material and the metal raw material are received in the calcination vessel moving along the conveyor in a mixed state, and react with each other at high temperature due to heat supplied from the horizontal furnace, whereby diffusion and crystal growth are achieved.

At this time, gas is generated during the reaction between the lithium raw material and the metal raw material. If the generated gas is not smoothly discharged out of the calcination vessel and the horizontal furnace, the surface of the lithium raw material and the surface of the metal raw material are covered with the gas, which prevents the maintenance of a uniform oxidizing atmosphere and thus the occurrence of uniform reaction.

A conventionally used calcination vessel has a square box-shaped structure as shown in FIG. 1. The calcination vessel 10 has an interior space 16, in which raw materials are received, formed by a bottom surface 12 and a plurality of side wall portions 14, and an upper surface facing the bottom surface 12 is open for introduction of raw materials and gas.

On industrial sites, in order to maximize productivity, calcination vessels 10a and 10b are often loaded on a conveyor (not shown) in a state of being stacked in multiple layers, such as two or three layers, as shown in FIG. 2. In this case, gas generated by reaction is not discharged from the calcination vessels in the center and at a lower end, causing problems such as uneven reaction.

Therefore, as shown in FIG. 3A, the problems are solved by forming upwardly protruding stack support portions 28 at corner regions of a calcination vessel 10′ and forming the flow of a fluid flow path 25 between the stack support portions 28.

However, as shown in FIG. 3A, the stack support portions 28 formed at the corner regions have the disadvantage that, when a plurality of calcination vessels 10′is disposed in a width direction and a longitudinal directions of the horizontal furnace, the protruding stack support portions 28 act as obstacles that hinder the smooth flow of a fluid. Specifically, as shown in FIG. 3B, since the stack support portion 28 has a structure bent in a “┐” shape, a vortex or swirling phenomenon of the fluid occurs at the corner regions A, causing trapping of the gas which is unable to flow.

Therefore, there is a need in the industry for a calcination vessel with a structure that can provide improved fluid flowability to significantly increase reaction uniformity, as recently better characteristics have been required for an electrode active material manufactured through calcination.

In addition, it has been confirmed that there is a problem in which the calcination vessel is damaged as the calcination vessel expands when the calcination vessel is subjected to heat and load while undergoing the calcination process for tens of hours, and this problem is also being highlighted in the manufacturing process, so there is strong demand for technology that can solve these problems.

### DISCLOSURE

### Technical Problem

Therefore, it is an object of the present invention to solve the above problems and other technical problems that have yet to be resolved.

As the result of deep research and a variety of simulations, the inventors of the present application have developed a calcination vessel with excellent structural stability capable of suppressing a fluid vortex or swirling phenomenon during a calcination process, thereby increasing reactivity and productivity, and preventing damage to the calcination vessel due to thermal expansion during repeated high-temperature calcination processes, as described below.

### Technical Solution

A calcination vessel for manufacturing electrode active materials according to the present invention to accomplish the above object includes a base portion forming a bottom surface of the calcination vessel, side wall portions extending upward from outer peripheries of the base portion to form a raw material receiving space, and at least one stack support portion extending upward from a part of an upper end of each side wall portion that is not a corner region where adjacent side wall portions abut each other.

As previously described, in a calcination vessel having a stack support portion located at a corner region, gas flows unevenly due to a fluid vortex phenomenon, whereby product quality and productivity are reduced. In contrast, in a structure in which a stack support portion is located at a part other than the corner region, as in the present invention, introduction of air or oxygen and discharge of generated gas are facilitated, whereby uniform reaction is achieved, and therefore it is possible to improve product quality and productivity.

In a first specific embodiment of the present invention, the calcination vessel for manufacturing electrode active materials may further include at least one structure reinforcement portion formed with a predetermined thickness from the side wall portion toward the raw material receiving space in order to structurally stabilize the side wall portion against heat and load.

The inventors of the present application have found that, if the calcination vessel is subjected to high temperature for a long time during the calcination process, heat accumulation occurs in the center of the base portion of the calcination vessel, and the accumulated heat causes thermal expansion radially from the center of the base portion, and the side wall portions are damaged by differential thermal expansion of the base portion, which causes the side wall portions to spread outward.

Specifically, referring to FIG. 4, which is a plan view schematically showing a hexahedral calcination vessel, at a corner region A where adjacent side wall portions 14a and 14b abut each other, for example, the side wall portions support each other at an angle of 90 degrees to provide structural stability while outward spread of the side wall portions due to thermal expansion is suppressed, whereas the region where the side wall portion 14b alone fights against thermal expansion of the base portion 12 is not separately supported, causing significant outward spread. In particular, it was confirmed that a central region B of the side wall portion 14b is directly affected by thermal expansion of the base portion 12, a spread phenomenon occurs as the side wall portion is pushed outward, and damage can easily occur when the load is applied by upper calcination vessels (not shown).

As a result, the central region of the base portion 12 swells during the thermal expansion process, and the central region B of the side wall portion 14b is sequentially pushed outward and spreads, and this spread phenomenon occurs in the remaining side wall portions 14a, 14c, and 14d. In the state in which a plurality of calcination vessels 10 is stacked, the heat expansion of the swelling region occurs along with the load applied from above, and the distance between the side wall portions 14a and 14c facing each other and the distance between the side wall portions 14b and 14d facing each other increase and, as a result, the side wall portions 14a, 14b, 14c, and 14d collapse in an outward direction, causing damage to the calcination vessel 10.

Therefore, the inventors of the present application anticipated that, if the stack support portion is formed, for example, in the center of the side wall portion, thereby ensuring smooth flow of the generated gas, and the side wall portion is structurally stabilized against thermal expansion and load through the structure reinforcement portion formed with the predetermined thickness from the side wall portion toward the raw material receiving space, it is possible to prevent damage to the calcination vessel, and this smooth gas fluidity and structural stabilization have been confirmed in the actual mass production process.

In a specific example, at least a part of the structure reinforcement portion may be in contact with the side wall portion and the base portion at the same time to fix the side wall portion and the base portion to each other. As previously described, when thermal expansion occurs in the state in which load is applied due to the stacked structure, if the structure reinforcement portion fixes the side wall portion and the base portion to each other, the structure reinforcement portion and the side wall portion are supported by each other at the region where the structure reinforcement portion and the side wall portion abut each other, and the structure reinforcement portion and the base portion are supported by each other at the region where the structure reinforcement portion and the base portion abut each other, whereby it is possible to maximally suppress thermal expansion.

As previously defined, the structure reinforcement portion is formed with a predetermined thickness from the side wall portion toward the raw material receiving space. In a preferred example, the thickness of the structure reinforcement portion extending toward the raw material receiving space may be 15 to 75% of the thickness of the side wall portion. If the thickness of the structure reinforcement portion is increased, the side wall portion is securely fixed, whereby durability may be improved. However, the inner receiving space is reduced, and the effect of reinforcing the side wall portion does not significantly increase if the thickness exceeds a certain level, and therefore it is preferable for the thickness of the structure reinforcement portion to be 75% or less of the thickness of the side wall portion. In contrast, if the thickness of the structure reinforcement portion is less than 15% of the thickness of the side wall portion, the effect of reinforcing the side wall portion may not be achieved. The thickness of the structure reinforcement portion is preferably 25 to 65% or less of the thickness of the side wall portion, and more preferably 32 to 52% or less of the thickness of the side wall portion. Here, if the structure reinforcement portion has a shape with an irregular thickness, the thickness of the structure reinforcement portion refers to the maximum thickness.

When the structure reinforcement portion satisfies predetermined height conditions while having a predetermined thickness, it is possible to further maximize the effect of reinforcing the side wall portion. In a specific example, the height of the structure reinforcement portion may be 10% or more of the maximum height of the calcination vessel. If at least a part of the structure reinforcement portion abuts the stack support portion, the height of the structure reinforcement portion may be 10% or more of the sum of the height of the side wall portion and the height of the stack support portion.

In a preferable example, the height of the structure reinforcement portion may be 10 to 100% of the maximum height of the calcination vessel, and in this case, 100% means that the height of the structure reinforcement portion is the same as the maximum height of the calcination vessel. If the height of the structure reinforcement portion is less than 10% of the maximum height of the calcination vessel, the effect of reinforcing the side wall portion may not be achieved. On the other hand, if the height of the structure reinforcement portion is 100% of the maximum height of the calcination vessel, the contact area with the upper calcination vessel increases, making it easier to share the load applied to the side wall portion, but the receiving space decreases, which may reduce productivity. The height of the structure reinforcement portion is preferably 15 to 90% of the maximum height of the calcination vessel, and more preferably 17 to 80% of the maximum height of the calcination vessel. Here, if the structure reinforcement portion has a shape with an irregular height, the height of the structure reinforcement portion means the maximum height.

In a specific example, the longitudinal center of the stack support portion may coincide with the longitudinal center of the side wall portion.

When considering the load of the upper calcination vessel, if the positions of the stack support portions located at each side wall portion are asymmetrical or if the positions of the stack support portions facing each other are misaligned, the load may be unbalanced when stacking the calcination vessels, which may cause stability issues. That is, stable stacking of the calcination vessels is possible if the stack support portions are located in the center of the side wall portion in a longitudinal direction. Here, the longitudinal direction refers to a direction parallel to the outer periphery of the base portion.

Meanwhile, in order to more effectively achieve the effect of reinforcing the side wall portion, the structure reinforcement portion may be formed so as to be at least adjacent to the position where the stack support portion is formed. As the load is applied to the stack support portion when the calcination vessels are stacked, there is a high risk of the region of the side wall portion where the stack support portion is formed being damaged if the central part of the base portion thermally expands, as previously described. Therefore, if the structure reinforcement portion is formed only at the corner region of the calcination vessel, the structure reinforcement portion may not be effective in preventing damage to the side wall portion area due to thermal expansion.

Therefore, an imaginary plane vertically extending downward from both ends of a lower surface of the stack support portion and at least a part of a contact surface of the structure reinforcement portion in contact with the side wall portion may abut each other. In this structure, the load of the upper calcination vessel(s) transferred through the stack support portion when stacking the calcination vessels may be smoothly shared by the structure reinforcement portion, and therefore it is possible to prevent damage. The structure reinforcement portion is formed at the central part of the side wall portion, rather than the corner region of the calcination vessel, and therefore it is possible to prevent damage to the side wall portion due to thermal expansion. If the structure reinforcement portion is formed at the position where the stack support portion is not formed and that is not the corner region, the side wall portions may be prevented from spreading due to thermal expansion, but it may be difficult to achieve a load-sharing effect. That is, by limiting the position of the structure reinforcement portion, it is possible to simultaneously address the problem of the side wall portions spreading due to thermal expansion and damage due to load. Preferably, the abutting ratio between the imaginary plane vertically extending downward from both ends of the lower surface of the stack support portion and the contact surface of the structure reinforcement portion in contact with the side wall portion is 50 to 100%.

More preferably, the longitudinal center of the structure reinforcement portion may coincide with the longitudinal center of the stack support portion, in which case it is possible to maximize the load-sharing effect. Here, the longitudinal direction refers to a direction parallel to the outer periphery of the base portion.

In a specific example, the length of the structure reinforcement portion may be 30 to 120% of the length of the stack support portion. As the length of the structure reinforcement portion increases, the effect of reinforcing the side wall portion increases, but if the length of the structure reinforcement portion exceeds a certain range, there is no significant change in the reinforcement effect, and only the receiving space may decrease. In contrast, if the length of the structure reinforcement portion is less than 30% of the length of the stack support portion, the effect of reinforcing the side wall portion may not be achieved. Therefore, the length of the structure reinforcement portion must be formed within an appropriate ratio to secure the receiving space and to achieve the effect of reinforcing the side wall portion, is preferably 40 to 100% of the length of the stack support portion, and more preferably 57 to 87% of the length of the stack support portion. Here, if the structure reinforcement portion has a shape with an irregular length, the length of the structure reinforcement portion means the maximum length.

The vertical sectional shape of the structure reinforcement portion is not restricted as long as it is possible to reinforce the side wall portion. For example, the structure reinforcement portion may have a horizontal sectional area that gradually increases from the upper end to the lower end of the structure reinforcement portion so as to achieve the effect of reinforcing the side wall portion while maximizing the raw material receiving space, or may have an arc shape that is concave downward. In addition, various other shapes, such as a convex arc, a polygon, or a combination thereof, are possible.

In a second specific embodiment of the present invention, the calcination vessel for manufacturing electrode active materials may have two or more stack support portions.

The calcination vessel with the above structure may produce a high-quality active material by suppressing the vortex phenomenon of the fluid that may occur near the stack support portion, thereby improving the fluidity of the fluid and providing more uniform reactivity. In addition, it is possible to significantly facilitate the introduction of air or oxygen for oxidation reaction and the discharge of gas generated during the calcination process and to minimize damage to the calcination vessel due to thermal expansion by maximally increasing the number of fluid flow paths, which are flow paths of the fluid.

The inventors of the present application have confirmed through technical attempts using various approaches that technical optimization of the stack support portion is particularly important for the manufacture of the calcination vessel that can achieve the above effects. The details thereof will be described below.

In a specific example, the stack support portion may not be located at the central region of the upper end of the side wall portion.

The calcination vessel enters and moves in the calcination furnace during the calcination process, and at this time, a fluid, such as air or oxygen, is supplied from a plurality of air supply portions on the side, and the region that most significantly affects the flow and diffusion of the fluid in each calcination vessel may be the central region of the upper end of the side wall portion. That is, if the central region of the upper end of the side wall portion is open, some of the fluid introduced therethrough may flow straight across the calcination vessel, and the remaining fluid may be diffused symmetrically to the left and right, whereby the area of the calcination vessel covered by the fluid may be maximized. Therefore, if the stack support portion is not located at the central region of the upper end of the side wall portion and is open, it is possible to maximize the fluid flow rate for each calcination vessel.

As previously defined, the number of stack support portions located at one side wall portion may be two or more, and preferably two stack support portions are formed symmetrically with respect to the center of the side wall portion in the width direction.

This structure enables a structure in which the stack support portion is not located at the central region of the upper end of the side wall portion while greatly increasing the number of subdivisions of the fluid flow path. In addition, the central region of the side wall portion, which has the highest thermal expansion during calcination, is effectively supported by two stack support portions, whereby thermal expansion is suppressed, and therefore it is possible to prevent damage to the calcination vessel.

Additionally, this structure enables that the load of the upper calcination vessel is supported by the remaining stack support portions that have not been damaged if some of the stack support portions are damaged by vibration or impact during movement of the calcination vessel.

In another specific example, the position and size of the stack support portion are specified within a certain range to maximize the intended effect while minimizing the problems that may be caused at the same time. The conditions will be described below.

In a first example, at least one of the stack support portions on one side wall portion may be configured such that the center of the stack support portion in the width direction is located at a distance of less than 67% from the center of the side wall portion with respect to the length from the center of the side wall portion to one end of the side wall portion.

If the value is small, this means that the stack support portion is close to the center of the side wall portion. In contrast, if the value is large, this means that the stack support portion is close to the corner of the side wall portion. If the value is 67% or more, the stack support portion that is close to the corner may cause a phenomenon similar to the vortex phenomenon of the fluid due to interaction with the stack support portion on the side wall portion adjacent thereto. In some cases, the minimum of the value may be set to 10% or more to minimize the possibility of the central region of the upper end of the side wall portion being closed. The value is preferably 40% to 60%, and more preferably 45% to 55%.

In a preferred example, one side wall portion may have a first stack support portion and a second stack support portion formed symmetrically with respect to the center of the side wall portion in the width direction, the first stack support portion may be configured such that the center of the first stack support portion in the width direction is located at a distance of less than 67% from the center of the side wall portion with respect to the length from the center of the side wall portion to one end of the side wall portion, and the second stack support portion may be configured such that the center of the second stack support portion in the width direction is located at a distance of less than 67% from the center of the side wall portion with respect to the length from the center of the side wall portion to the other end of the side wall portion.

In a second example, the sum of widthwise lengths of the stack support portions formed at one side wall portion may be 25% or more of the length of the side wall portion.

The smaller the sum of the widthwise lengths of the stack support portions formed at one side wall portion, the better for securing the fluid flow path, but if the sum of the widthwise lengths of the stack support portions is less than 25% of the length of the side wall portion, the durability of the stack support portions is low and the stack support portions may be damaged by the upper calcination vessel when the calcination vessels are stacked. In some cases, the maximum of the value may be set to 90% or less to minimize the problem of fluid flow deterioration, which occurs at higher values. The value is preferably 40% to 60%, and more preferably 45% to 55%.

In a third example, the thickness of the stack support portion may be 50% or more of the thickness of the side wall portion at which the stack support portion is located.

As the thickness of the stack support portion increases under the condition that the thickness of the stack support portion is 50% or more of the thickness of the side wall portion, as described above, durability may be improved, and if possible, it may be necessary for the thickness of the stack support portion to be 120% or less of the thickness of the side wall portion. This is because, if the thickness of the stack support portion is greater than 120% of the thickness of the side wall portion, problems with formability of the calcination vessel may occur and the load of the calcination vessel increases, which may cause the lower calcination vessel to be overloaded and damaged. The value is preferably 80% to 120%, and more preferably 90% to 110%.

In a fourth example, the height of the stack support portion may be 40% or less of the total height of the calcination vessel.

If the height of the stack support portion is greater than 40% of the total height of the calcination vessel, the stack support portion may be damaged due to low durability, and productivity may decrease due to the decrease in the number of stacking layers that can be secured as the height of each layer increases when stacking the calcination vessels in multiple layers. If possible, it may be better to set the height of the stack support portion to 10% or more of the total height of the calcination vessel to ensure a sufficient fluid flow path. The value is preferably 10% to 30%, and more preferably 15% to 25%.

In a fifth example, the interval between the stack support portions formed at one side wall portion may be 15% or more of the widthwise length of the side wall portion.

As the interval between the stack support portions at one side wall portion increases, the fluid flow path becomes wider, and therefore it may be necessary to set the interval between the stack support portions to at least 15% or more of the widthwise length of the side wall portion. However, if the interval between the stack support portions increases, the fluid flow path adjacent to the corner region may become narrow, which may cause a phenomenon similar to the vortex phenomenon of the fluid, and therefore it is preferable for the value to be 50% or less. The value is preferably 17% to 50%, and more preferably 20% to 30%.

Unlike the above conditions, the shape of the side surface of the stack support portion is not particularly limited as long as it is possible to smoothly support the load of the upper calcination vessel while not interfering with the formation of the fluid flow path. For example, the shape of the side surface of the stack support portion may be a polygonal shape, a convex circular arc shape, or a combination thereof.

In the calcination vessel according to the present invention, the stack support portion is formed on the side wall portion to form a fluid flow path between the stack support portions. The fluid flow path is formed at an upper end of the side wall portion to serve as a passageway for fluids inside and outside the raw material receiving space, and is formed at an upper end of at least one side wall portion. In an embodiment, the fluid flow path is located at both ends of the side wall portion having the predetermined thickness, i.e., at the corner region of the calcination vessel, and a part of the upper end of the side wall portion is formed in an open shape.

An opening surface of the fluid flow path includes a first opening surface formed parallel to the longitudinal direction of the upper surface of the side wall portion and a second opening surface formed on the side surface of the stack support portion while abutting the first opening surface. The first opening surface may be formed in a straight line parallel to the longitudinal direction of the side wall portion, but the first opening surface may be irregularly formed in order to facilitate the flow of the fluid. The second opening surface connects the first opening surface and the upper end of the stack support portion to each other, and may be formed in a vertical direction without being formed at an angle. However, if the second opening surface is formed in the vertical direction, when the calcination vessels are stacked in multiple layers, the second opening surface and both ends of the side wall portion and the part where the second opening surface and the first opening surface abut each other are subject to concentrated impact and load, which may easily cause damage. Therefore, it may be preferable for the second opening surface to be inclined in order to ensure high durability in the part where the fluid flow path is formed.

Therefore, in a specific example, assuming that the upper surface of the stack support portion is a first opening surface and the side surface of the stack support portion abutting the first opening surface is a second opening surface, the first opening surface may be parallel to the base portion and the second opening surface may be inclined from the base portion.

The structure may effectively support and distribute the load of the upper calcination vessel, thereby increasing structural stability. For example, the inclination of the second opening surface may be 45° to 90° with respect to the first opening surface such that a trapezoidal shape is formed.

In the present invention, the first opening surface and the second opening surface are distinguished for the sake of convenience, but if necessary, only an inclined second opening surface may be provided without the first opening surface, and the second opening surface may have an arc shape or a curved shape.

In some cases, the lower end of the base portion may be provided with a fixing portion corresponding to the stack support portion of the lower calcination vessel such that the stacked state of the calcination vessels can be stably supported when the calcination vessels are stacked in multiple layers.

The fixing portion helps the stacked calcination vessels to be fixed in their proper positions by suppressing shaking during movement of the calcination vessels, and the shape of the fixing portion is not particularly restricted. For example, a concave fixing portion may be formed in the lower end of the base portion of the upper calcination vessel, and the upper end of the stack support portion of the lower calcination vessel may be introduced into the concave fixing portion.

In addition, the present invention provides a calcination apparatus, wherein a plurality of calcination vessels is introduced into a calcination furnace along a rail in the state in which the calcination vessels are horizontally continuously disposed and at the same time vertically stacked in multiple layers.

The calcination apparatus may be a roller hearth kiln (RHK) calcination type calcination apparatus, wherein calcination vessels for manufacturing electrode active materials, in the raw material receiving space of each of which raw materials have been received, are introduced into a calcination furnace, such as a horizontal furnace, along a rail in the state in which the calcination vessels are horizontally continuously disposed and at the same time vertically stacked in multiple layers. The RHK calcination type calcination apparatus, excluding the calcination vessel, is well known in the art to which the present invention pertains, and therefore a detailed description thereof will be omitted from this specification.

In addition, the present invention provides a calcination vessel assembly including a plurality of calcination vessels disposed in a 2×2 or more horizontal array on a plane.

As previously defined, the calcination vessel includes a base portion forming a bottom surface of the calcination vessel, side wall portions extending upward from outer peripheries of the base portion to form a raw material receiving space, and at least two stack support portions extending upward from an upper end of each side wall portion that is not a corner region where adjacent side wall portions abut each other.

Therefore, the calcination vessel according to the present invention has the feature of enabling uniform reaction during calcination by providing a plurality of subdivided fluid flow paths due to structural differences based on the position, size, and number of the stack support portions, and as a result, the 2×2 horizontal array, which is the smallest array unit when disposed horizontally, has a structure that is different from the prior art.

In a specific example, when the calcination vessels are disposed in a 2×2 horizontal array on a plane, at least six fluid flow paths parallel to the base portions of the calcination vessels, having an angle of 45° to the side wall portions, and parallel to each other may be formed, and preferably six to twelve fluid flow paths are formed.

### Effects of the Invention

As is apparent from the above description, a calcination vessel according to the present invention is capable of improving the flow of a fluid by preventing eddy currents or vortices when a plurality of calcination vessels is horizontally disposed and stacked in multiple layers. In addition, it is possible to improve productivity and stability by suppressing irregular thermal expansion caused by a high-temperature calcination process and thus firmly supporting high load applied to a side wall portions portion of the calcination vessel. Furthermore, it is possible to improve fluidity and to provide uniform reactivity by facilitating introduction of air or oxygen and discharge of generated gas.

### BRIEF DESCRIPTION OF DRAWINGS

The above and other objects, features and other advantages of the present invention will be more clearly understood from the following detailed description taken in conjunction with the accompanying drawings, in which:

FIG. 1 is a schematic perspective view of an example of a conventional calcination vessel;

FIG. 2 is a schematic view showing the state in which a plurality of calcination vessels, one of which is shown in FIG. 1, is horizontally and vertically disposed;

FIG. 3A is a schematic perspective view of another example of the conventional calcination vessel;

FIG. 3B is a schematic view showing a partial fluid flow in the state in which a plurality of calcination vessels, one of which is shown in FIG. 3A, is horizontally vertically disposed;

FIG. 4 is a plan view schematically showing a phenomenon of thermal expansion spreading from a base portion in a hexahedral calcination vessel;

FIG. 5 is a plan view and a partial see-through side view of a calcination vessel according to a first specific embodiment of the present invention;

FIG. 6 is a plan view and a partial see-through side view of a calcination vessel according to another embodiment in relation to FIG. 5;

FIG. 7 is a schematic perspective view of another example of the conventional calcination vessel;

FIG. 8 is a side view schematically showing the state in which two calcination vessels according to another embodiment are stacked in relation to FIG. 5;

FIG. 9A is a schematic perspective view of a calcination vessel according to a second specific embodiment of the present invention;

FIG. 9B is a side view of the calcination vessel of FIG. 9A;

FIG. 9C is a plan view of the calcination vessel of FIG. 9A;

FIG. 10 is a schematic side view of a calcination vessel according to another embodiment in relation to FIG. 9A;

FIG. 11 is a schematic view showing fluid flow paths in a calcination vessel assembly having a 2×2 horizontal array of calcination vessels based on the calcination vessel of FIG. 9A;

FIG. 12 is a schematic view showing fluid flow paths in a calcination vessel assembly having a 2×2 horizontal array of calcination vessels based on a calcination vessel having one stack support portion formed at a side wall portion;

FIG. 13 is a schematic view showing the flow of a fluid when a calcination vessel assembly having an n×n horizontal array of calcination vessels based on FIG. 11 is moved into a calcination furnace;

FIG. 14 is a schematic view showing the flow of a fluid when a calcination vessel assembly having an n×n horizontal array of calcination vessels based on FIG. 12 is used;

FIGS. 15A and 15B are images showing the results of fluid simulation in FIG. 13; and

FIGS. 16A and 16B are images showing the results of fluid simulation in FIG. 14.

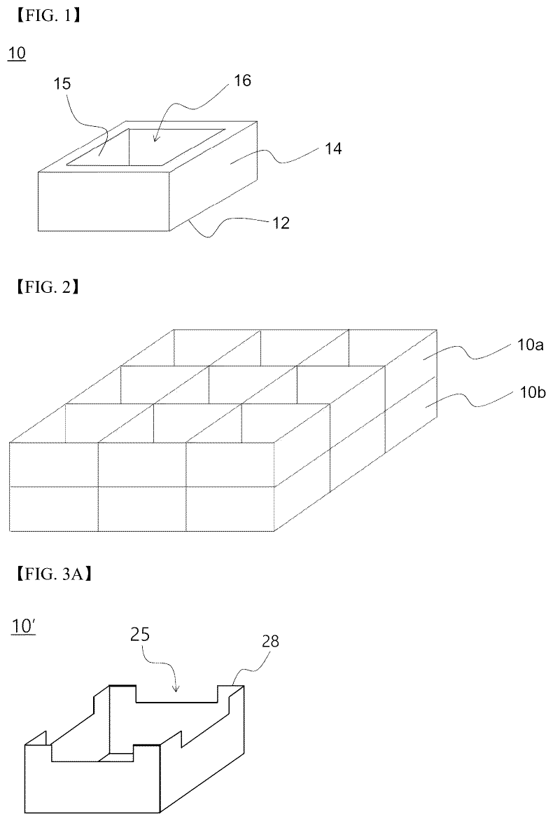

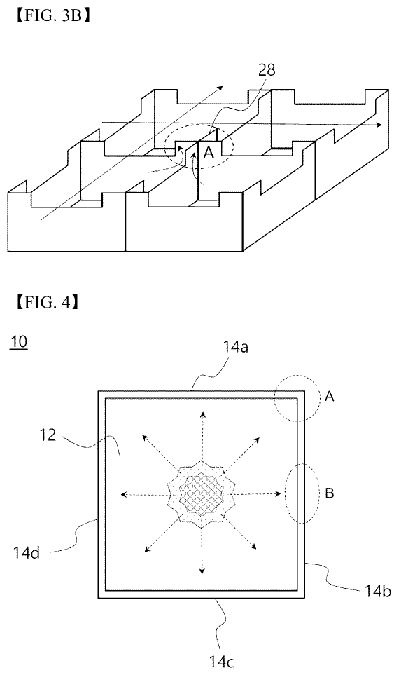

### DETAILED DESCRIPTION OF THE INVENTION

Hereinafter, embodiments of the present invention will be described in detail with reference to the accompanying drawings; however, the category of the present invention is not limited thereto.

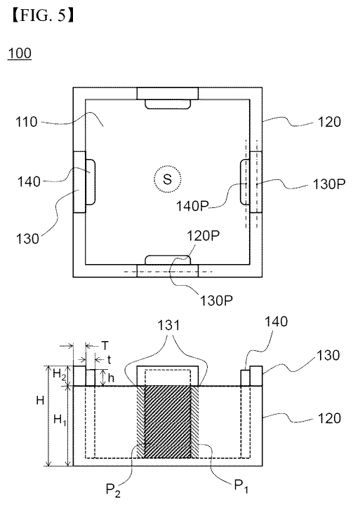

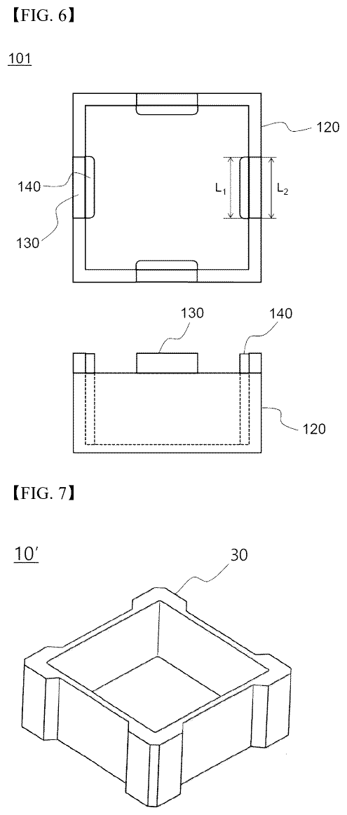

A calcination vessel according to a first specific embodiment of the present invention will be described with reference to FIGS. 5 and 6, which schematically show exemplary calcination vessels thereof. Each of FIGS. 5 and 6 is a plan view and a partial see-through side view of the calcination vessel.

First, referring to FIG. 5, the calcination vessel 100 according to the present invention includes a base portion 110. The base portion 110 forms a bottom surface of the calcination vessel 100, and has a polygonal shape to receive large amounts of raw materials and at the same time to allow a plurality of calcination vessels to be disposed thereon in tight contact with each other in a movement direction and a width direction of a conveyor (not shown). The shape of the base portion 110 is not particularly limited as long as calcination vessels can be disposed on the base portion in tight contact with each other such that empty space is minimized, but the more closely the calcination vessels are disposed, the more raw material storage space per unit area increases, thereby increasing productivity, so a triangle, a square, or a hexagon is preferable.

A side wall portion 120 extends upward along an outer periphery of the base portion 110, and a raw material receiving space S is formed by the base portion 110 and the side wall portion 120 surrounding the base portion 110. The number of side wall portions 120 corresponds to the shape of the base portion 110, for example, if the base portion 110 is square in shape, four side wall portions 120 may be provided, and if the base portion 110 is hexagonal in shape, six side wall portions 120 may be provided. Due to the nature of the calcination vessel 100 for electrode active materials that receives powdered raw materials, it is preferable for the side wall portions 120 be formed at all of the outer peripheries of the base portion 110 such that the raw materials do not leak out.

A stack support portion 130 provides the flow of a fluid path while helping to stack the calcination vessels 100 in a plurality of layers to provide a stable stack structure. To this end, the stack support portion may extend from an upper surface of each of the side wall portions 120 and may be formed only on some of the side wall portions if the load of upper calcination vessel(s) can be balanced according to the shape of the base portion 110. One stack support portion 130 may be formed on one side wall portion, or two or more stack support portions 130 may be formed on one side wall portion.

The stack support portion 130 may be formed, for example, in a central region of the upper surface of the side wall portion 120 such that the flow of a fluid path is located at each of both ends of the side wall portion 120, as shown in FIG. 6. This structure provides a preferable example in implementing a structure in which the stack support portion 130 is not located at an upper end of at least one of the intersecting regions (corner regions) where the side wall portions that are adjacent to each other come into contact with each other, as defined above. That is, by allowing the fluid to flow without the stack support portion 130 being located at the corner region of the calcination vessel 100, the calcination vessel may have a structure that is more favorable for flow path formation than when the stack support portion 130 is formed in the corner region.

Referring back to FIG. 5, a structure reinforcement portion 140 is formed with a predetermined thickness from the side wall portion 120 toward the raw material receiving space S so as to structurally stabilize the side wall portion 120 against thermal expansion and load. That is, the structure reinforcement portion makes the side wall portion 120 more robustly withstand the load of upper calcination vessel(s), and prevents damage to the side wall portion 100 due to thermal expansion of the base portion 110 even if the calcination vessel 100 expands due to heat. Although the amount of raw material that can be received per unit area may be reduced as the structure reinforcement portion 140 extends toward the raw material receiving space S, reinforcement of the side wall portion 120 may increase the number of layers, thereby achieving the effect of increasing the amount of raw material that can be received per unit area.

Therefore, the structure reinforcement portion 140 prevents damage to the side wall portion 120 outwardly of the calcination vessel due to thermal expansion, and as shown in the figure, a great part of the structure reinforcement portion 140 is fixed in contact with the base portion 110 and the side wall portion 120 at the same time, whereby structural stability is improved, and therefore it is possible to more effectively prevent separation between the base portion 110 and side wall portion 120.

The structure reinforcement portion 140 is formed on the side wall portion 120 inwardly thereof, and considering product productivity by calcination and the structural stability of the calcination process, the thickness t of the structure reinforcement portion 140 extending toward the raw material receiving space may be 15 to 75% of the thickness T of the side wall portion 120, and the height h of the structure reinforcement portion 140 may be 10% or more of the maximum height H of the calcination vessel 100 or the sum of the height H₁ of the side wall portion and the height H₂ of the stack support portion. In the figures, the height H of the calcination vessel 100 is equal to the sum of the height H₁ of the side wall portion and the height H₂ of the stack support portion.

The longitudinal center 130P of the stack support portion 130 is formed so as to coincide with the longitudinal center 120P of the side wall portion 120 such that the load of the upper calcination vessels (not shown) is added in a balanced manner so as to enable stable stacking.

Similarly, the longitudinal center 140P of the structure reinforcement portion 140 is formed at the position that substantially coincides with the longitudinal center 130P of the stack support portion 130 on the same axis, thereby maximizing the load-sharing effect.

In addition, an imaginary plane P₁ extending vertically downward from both ends 131 of a lower surface of the stack support portion 130 and a contact surface P₂ of the structure reinforcement portion 140 in contact with the side wall portion 120 greatly overlap each other, thereby solving the problem of separation of the side wall portions 120 by thermal expansion and the problem of damage due to the load of the upper calcination vessel(s).

Referring to FIG. 6, in a calcination vessel 101, the length L₁ of the structure reinforcement portion 140 is substantially equal to the length L₂ of the stack support portion 130, but the length L₁ of the structure reinforcement portion 140 may be less than the length L₂ of the stack support portion 130, as shown in FIG. 5, or the length L₁ of the structure reinforcement portion 140 may be greater than the length L₂ of the stack support portion 130, unlike FIG. 5, within a certain range as long as the receiving space can be secured and the effect of reinforcing the side wall portion can be achieved.

The structure of each of the calcination vessels 100 and 101 according to the present invention, as described above, is distinguished from a conventional structure in which the outside of the side wall portion is reinforced, as shown in FIG. 7. Unlike the structures of FIGS. 5 and 6, FIG. 7 shows a calcination vessel 10′ with a reinforcement portion 30 added to the outside, which has the following structural problems.

Specifically, the structure reinforcement portion 30 extending to the outside of the calcination vessel 10′ does not hold the calcination vessels 10′ firmly together when a plurality of calcination vessels 10′ is disposed horizontally because the contact area between the calcination vessels 10′ is reduced, whereby the calcination vessels 10′ loaded on the conveyor (not shown) move slightly due to vibration that occurs during transportation. Since a horizontal furnace is tens of meters long, the small movements of the calcination vessels 10′ are repeated, causing the contact parts to shift and the array of the calcination vessels 10′ to become distorted, the thick corner region collides with the relatively thin region, causing damage to the vessel, and the calcination vessels located on the outer peripheries of the conveyor fall off the conveyor. In addition, empty spaces in which the calcination vessels 10′ are not in contact with each other are formed between the calcination vessels 10′ that are disposed. When disposed, therefore, the empty spaces reduce the number of calcination vessels 10′ that can be loaded in the same space and the amount of electrode active material raw materials, which is undesirable in terms of productivity.

In addition, in this case, calcination vessels 10b located at the bottom during multi-layer stacking may not discharge the gas generated by reaction, causing problems such as uneven reaction.

In contrast, each of the calcination vessels 100 and 101 according to the present invention, illustrated in FIGS. 5 and 6, as explained above, solves the structural problems of the calcination vessel 10′ of FIG. 7 at once.

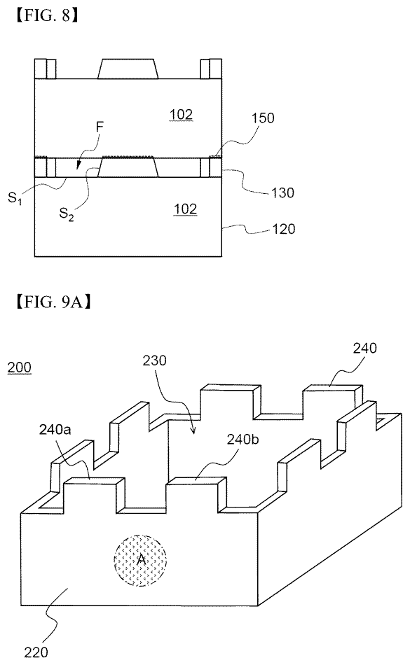

Meanwhile, referring to FIG. 8, which illustrates a calcination vessel 102 according to the present invention, as seen in the figure, when a plurality of calcination vessels 102 is stacked, a fluid flow path F is formed between the calcination vessels 102. An opening surface of the fluid flow path F includes a first opening surface S₁ formed parallel to the longitudinal direction of the upper surface of the side wall portion 120, and a second opening surface S₂ formed on a side surface of the stack support portion 130 while abutting the first opening surface S₁. In order to provide high durability to the region where the fluid flow path F is formed, the second opening surface S₂ has an upwardly inclined structure.

In addition, in order to maintain a stable stacking state even when shaken by vibration, a fixing recess 150 having a corresponding shape is formed at a corresponding position of the lower surface of the base portion of the calcination vessel 101 such that a part of the upper end of the stack support portion 130 can be received.

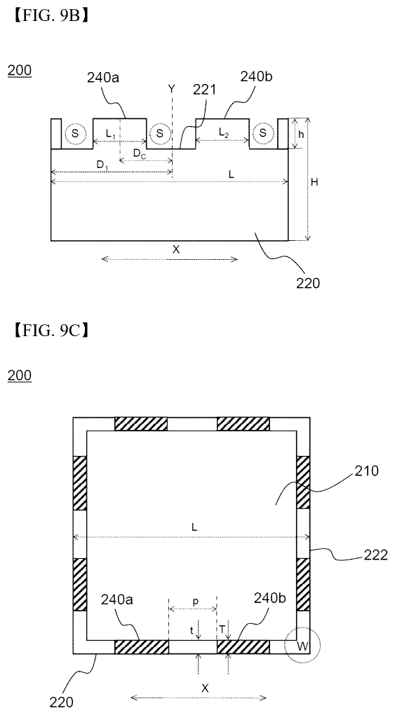

FIG. 9A is a schematic perspective view of a calcination vessel according to a second specific embodiment of the present invention, FIG. 9B is a side view of the calcination vessel, and FIG. 9C is a plan view of the calcination vessel.

Referring to these figures, the calcination vessel 200 according to the present invention includes a base portion 210, a side wall portion 220, and a stack support portion 240.

The side wall portion 220 extends upward along the outer periphery of the base portion 210, and a raw material receiving space 230 is formed by the base portion 210 and the side wall portion 220 surrounding the base portion 210. The number of side wall portions 220 corresponds to the shape of the base portion 210, and for example, if the base portion 210 has a square shape as shown in the figures, four side wall portions 220 may be provided.

The stack support portion 240 provides the flow of a fluid path while assisting in the multilayer stacking of the calcination vessels 200 to provide a stable stack structure. To this end, the stack support portion 240 may extend from an upper surface of each of the side wall portions 220.

The structure in which two stack support portions 240a and 240b are formed on one side wall portion 220 is shown, wherein the stack support portions 240a and 240b are formed symmetrically with respect to the center Y of the side wall portion 220 in a width direction X, whereby no stack support portion is located at the center (Y) of an upper end 221 of the side wall portion 220. The space where the stack support portions 240a and 240b are not located forms the flow of a fluid path S.

As shown in FIG. 9C, no stack support portion is located at an upper end of a corner region W, which is an intersection region where adjacent side wall portions 220 and 222 abut each other, and therefore a fluid vortex phenomenon does not occur.

In order to further secure the fluid flow path, three or more stack support portions may be formed, but as the number of stack support portions increases, it is difficult for the fluid to pass between the stack support portions, and therefore the optimal number of stack support portions that can secure the fluid flow path most smoothly may be two.

The position and size of the stack support portion may be set within a predetermined range as follows, thereby optimizing the function of the calcination vessel.

First, based on the width direction X, the distance Dc by which the center of the stack support portion 240A is spaced apart from the center Y of the side wall portion 220 may be less than 67% of the length D₁ from the center Y of the side wall portion 220 to one end of the side wall portion 220. The preferable position ratio (D_{C}/D₁) is 40% to 60%.

Second, based on the width direction X, the sum (L₁+L₂) of the length L₁ of the stack support portion 240a formed on the side wall portion 220 and the length L₂ of the stack support portion 240b may be 25% or more of the length L of the side wall portion 220. The preferable length ratio ((L₁+L₂)/L) is 40% to 60%.

Third, the thickness t of each of the stack support portions 240a and 240b may be 50% or more of the thickness T of the side wall portion 220. The preferred thickness ratio (t/T) is 80% to 120%.

Fourth, the height h of each of the stack support portions 240a and 240b may be 40% or less of the total height H of the calcination vessel 200. The preferred height ratio (h/H) is 10% to 30%.

Fifth, the interval p between the stack support portions 240a and 240b at the side wall portion 220 may be 15% or more of the length L of the side wall portion 220 in the width direction X. The preferred interval ratio (p/L) is 17% to 50%.

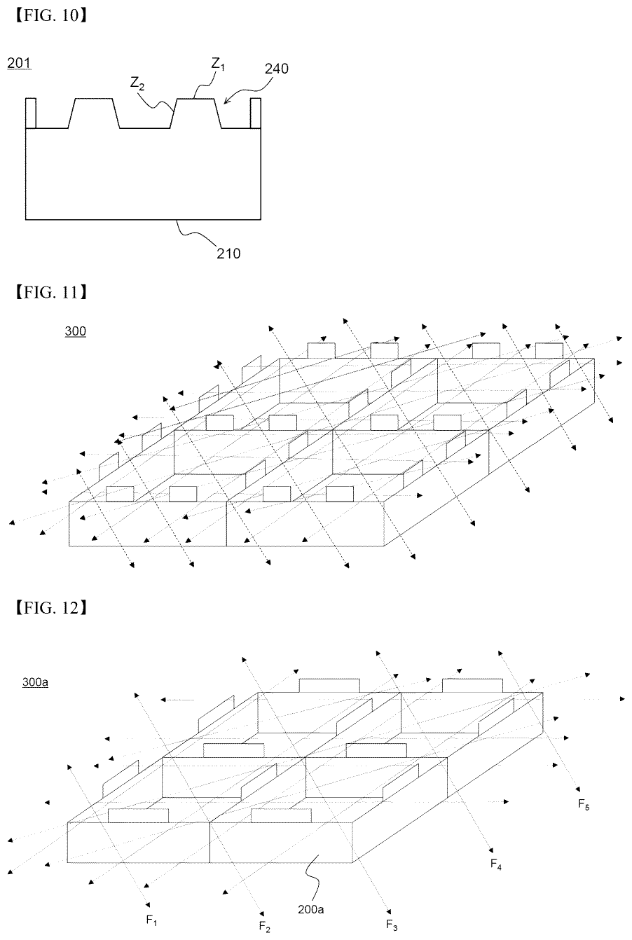

FIG. 10 is a schematic side view of a calcination vessel according to another embodiment in relation to FIG. 9A.

Referring to FIG. 10, in the calcination vessel 201, a first opening surface Z₁, which is an upper surface of a stack support portion 240, is parallel to a base portion 210, and a second opening surface Z₂, which is a side surface of the stack support portion 240 that is in contact with the first opening surface Z₁, is inclined at an angle of 45 degrees to less than 90 degrees to the base portion 210. This structure has the effect of improving stability against load.

FIG. 11 is a schematic view showing fluid flow paths in a calcination vessel assembly having a 2×2 horizontal array of four calcination vessels based on the calcination vessel of FIG. 9A, and FIG. 12 is a schematic view showing a calcination vessel assembly having a 2×2 horizontal array of calcination vessels based on a calcination vessel having one stack support portion formed at a side wall portion for comparison therewith.

First, referring to FIG. 12, in a calcination vessel assembly 300a having a 2×2 horizontal array of calcination vessels formed using a calcination vessel 200a having one stack support portion formed at a side wall portion, it can be seen that there are a maximum of five fluid flow paths F₁, F₂, F₃, F₄, and F₅ that are parallel to base portions of the calcination vessels, have an angle of 45° to the side wall portions, and are parallel to each other.

In contrast, referring to FIG. 11, it can be seen that a calcination vessel assembly 300 based on the calcination vessel of FIG. 9A has a total of nine fluid flow paths obtained from further subdivision of fluid flow paths with the above conditions. The increase in the number of fluid flow paths in a diagonal direction further promotes the flow of a fluid in the calcination vessel, thereby improving reaction uniformity during calcination.

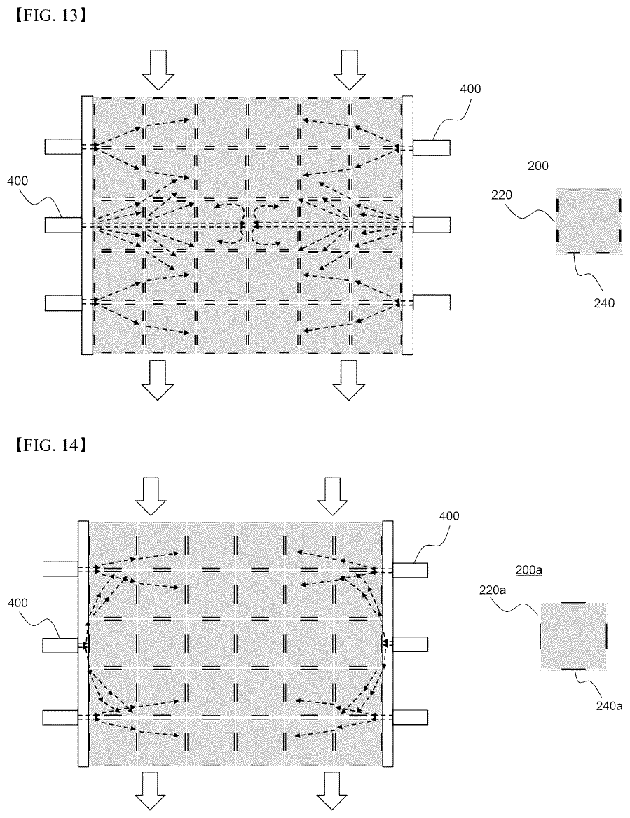

FIG. 13 is a schematic view showing the flow of a fluid when a calcination vessel assembly having an n×n horizontal array of calcination vessels based on FIG. 11 is moved into a calcination furnace to which a fluid is supplied from an air supply portion, and FIG. 14 is a schematic view showing the flow of a fluid when a calcination vessel assembly having an n×n horizontal array of calcination vessels based on FIG. 12 is used for comparison therewith.

Referring to FIG. 13, the calcination vessel 200 receives a fluid from the air supply portion 400 located at a side surface of the calcination furnace while being moved in the calcination furnace in an advance direction. At this time, it can be seen that various fluid flow and diffusion phenomena occur in the calcination vessel 200, in which two stack support portions 240 are formed at each side wall portion 220, due to a plurality of fluid flow paths.

In contrast, referring to FIG. 14, the calcination vessel 200a has one stack support portion 240a formed at an upper end of the center of a side wall portion 220a. As a result, a fluid may be introduced only through the corner region where the stack support portion 240a is not formed, whereby the number of fluid flow paths is very limited, and it can be seen that uniform fluid flow is not achieved. In particular, since the upper end of the center of the side wall portion 220a is blocked by the stack support portion 240a, the fluid is not directly introduced through the center of the calcination vessel 200a, whereby it is easy to predict that fluid flowability is greatly reduced.

As can be seen from FIGS. 11 and 13, when a calcination vessel assembly for calcination is constituted using the calcination vessel of FIG. 9A, it is possible not only to generate uniform fluid flow while forming a plurality of subdivided fluid flow paths, thereby increasing reaction uniformity, but also to increase thermal stability during calcination, thereby minimizing damage.

The calcination vessel is inevitably subjected to high temperatures when reactants are calcined. In this regard, referring to FIG. 9A, a central portion A of the side wall portion 220 has the highest thermal expansion, causing the side wall portion 220 to collapse outwardly of the calcination vessel 200.

However, in the calcination vessel 200, two stack support portions 240a and 240b are formed symmetrically around a central portion A of the side wall portion 220, it is possible to suppress thermal expansion of the central portion A of the side wall portion 220 while supporting the load of the upper calcination vessel (not shown) when stacking and to prevent damage to the side wall portion 220 due to thermal expansion.

In addition, if some of the stack support portions of the calcination vessel 200 are damaged by vibration or impact during movement, the load of the upper calcination vessel may be supported by the remaining stack support portions that have not been damaged.

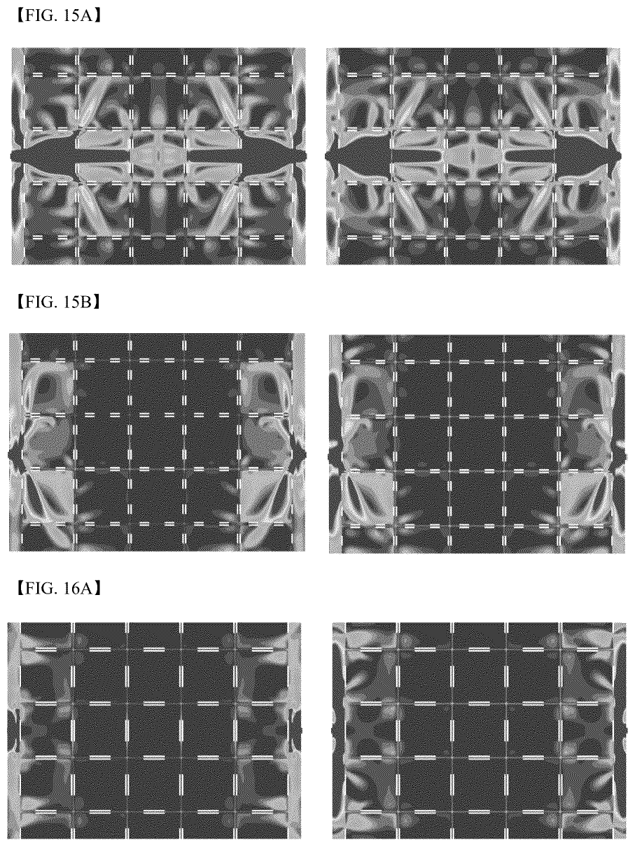

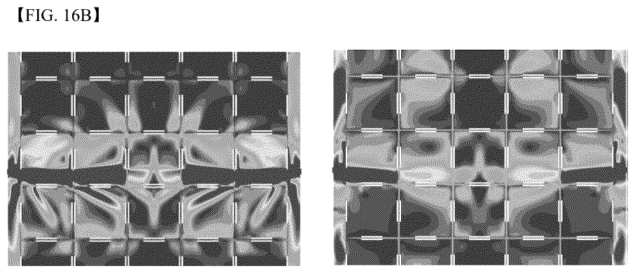

FIGS. 15A and 15B are images showing the results of fluid simulation in FIG. 13, and FIGS. 16A and 16B are images showing the results of fluid simulation in FIG. 14.

Specifically, each of the calcination vessel assembly of FIG. 13 and the calcination vessel assembly of FIG. 14 was set to have a structure in which the calcination vessels were vertically stacked in three layers, and fluid simulation was performed under the flow rate conditions for each calcination vessel of <Under 20 m³/hr+Side 40 m³/hr>. In each figure, the image on the left shows the results of fluid simulation of the first layer, and the image on the right shows the results of fluid simulation of the third layer.

In addition, the results when the calcination vessel assembly passed through the air supply port and when air was supplied from the upper end of the center of the side wall portion of the calcination vessel are shown in FIGS. 15A and 16A, respectively, and the results when air was supplied from the region adjacent to the corner are shown in FIGS. 15B and 16B, respectively.

First, referring to FIG. 15A, in the calcination vessel assembly of FIG. 13, a fluid inlet is located at the upper end of the center of the side wall portion, and it can be seen that the fluid flows smoothly in both horizontal directions based on the fluid inlet and that the fluid reaches the innermost calcination vessel well.

In response thereto, referring to FIG. 16B, in the calcination vessel assembly of FIG. 14, the fluid inlet is located at the corner region of the side wall portion, and when a fluid is introduced therethrough, the fluid is smoothly introduced, but the vertical introduction width is relatively small, which reduces the effect of air supply to the calcination vessels located at the outer periphery. Moreover, the air supply deviation between the first layer of the image on the left and the third layer of the image on the right is very large, indicating low work reliability.

Next, referring to FIG. 15B, in the calcination vessel assembly of FIG. 13, it can be seen that, even when air supply is obstructed by the stack support portion as the calcination vessel assembly is moved, a part of the fluid is introduced in the diagonal direction.

In response thereto, referring to FIG. 16A, in the calcination vessel assembly of FIG. 14, it can be seen that, when air supply is obstructed by the stack support portion, the air supply is practically blocked, and fluid introduction hardly occurs.

Therefore, it has been proven that the calcination vessel assembly based on the calcination vessel of FIG. 11 can provide a significantly better fluid flow than the calcination vessel assembly of FIG. 14 when comparing the results of the fluid simulation of FIGS. 15A and 15B with the results of the fluid simulation of FIGS. 16A and 16B.

Those skilled in the art to which the present invention pertains will appreciate that various applications and modifications are possible within the category of the present invention based on the above description.

1. A calcination vessel for manufacturing electrode active materials, the calcination vessel comprising:
a base portion forming a bottom surface of the calcination vessel;
side wall portions extending upward from outer peripheries of the base portion to form a raw material receiving space; and
at least one stack support portion extending upward from a part of an upper end of each side wall portion that is not a corner region where adjacent side wall portions abut each other.

2. The calcination vessel according to claim 1, comprising at least one structure reinforcement portion formed with a predetermined thickness from the side wall portion toward the raw material receiving space in order to structurally stabilize the side wall portion against heat and load.

3. The calcination vessel according to claim 2, wherein at least a part of the structure reinforcement portion is in contact with the side wall portion and the base portion at the same time to fix the side wall portion and the base portion to each other.

4. The calcination vessel according to claim 2, wherein a thickness of the structure reinforcement portion extending toward the raw material receiving space is 15 to 75% of a thickness of the side wall portion.

5. The calcination vessel according to claim 2 4, wherein a height of the structure reinforcement portion is 10% or more of a maximum height of the calcination vessel.

6. The calcination vessel according to claim 2, wherein a longitudinal center of the stack support portion coincides with a longitudinal center of the side wall portion.

7. The calcination vessel according to claim 2, wherein an imaginary plane vertically extending downward from both ends of a lower surface of the stack support portion and at least a part of a contact surface of the structure reinforcement portion in contact with the side wall portion abut each other.

8. The calcination vessel according to claim 2, wherein a longitudinal center of the structure reinforcement portion coincides with a longitudinal center of the stack support portion on the same axis.

9. The calcination vessel according to claim 6, wherein a length of the structure reinforcement portion is 30 to 120% of a length of the stack support portion.

10. The calcination vessel according to claim 1, wherein the stack support portion is provided in two or more.

11. The calcination vessel according to claim 10, wherein the stack support portion is not located at a central region of an upper end of the side wall portion.

12. The calcination vessel according to claim 10, wherein two stack support portions are formed symmetrically with respect to a center of one side wall portion in a width direction.

13. The calcination vessel according to claim 10, wherein at least one of the stack support portions on one side wall portion is configured such that a center of the stack support portion in a width direction is located at a distance of less than 67% from a center of the side wall portion with respect to a length from the center of the side wall portion to one end of the side wall portion.

14. The calcination vessel according to claim 10, wherein
one side wall portion has a first stack support portion and a second stack support portion formed symmetrically with respect to a center of the side wall portion in a width direction,
the first stack support portion is configured such that a center of the first stack support portion in a width direction is located at a distance of less than 67% from a center of the side wall portion with respect to a length from the center of the side wall portion to one end of the side wall portion, and
the second stack support portion is configured such that a center of the second stack support portion in a width direction is located at a distance of less than 67% from the center of the side wall portion with respect to a length from the center of the side wall portion to the other end of the side wall portion.

15. The calcination vessel according to claim 10, wherein a sum of widthwise lengths of the stack support portions formed at one side wall portion is 25% or more of a length of the side wall portion.

16. The calcination vessel according to claim 10, wherein a thickness of the stack support portion is 50% or more of a thickness of the side wall portion at which the stack support portion is located.

17. The calcination vessel according to claim 10, wherein a height of the stack support portion is 40% or less of a total height of the calcination vessel.

18. The calcination vessel according to claim 10, wherein an interval between the stack support portions formed at one side wall portion is 15% or more of a widthwise length of the side wall portion.

19. The calcination vessel according to claim 2, wherein a vertical sectional shape of the structure reinforcement portion is a concave circular arc, a convex circular arc, a polygonal shape, or a combination of two or more thereof.

20. The calcination vessel according to claim 2, wherein, when assuming that an upper surface of the stack support portion is a first opening surface and a side surface of the stack support portion abutting the first opening surface is a second opening surface, the first opening surface is parallel to the base portion and the second opening surface is inclined from the base portion.

21. The calcination vessel according to claim 2, wherein the base portion is provided at a lower end thereof with a fixing portion corresponding to the stack support portion of the calcination vessel located thereunder so as to stably support calcination vessels when the calcination vessels are stacked in multiple layers.

22. A roller hearth kiln (RHK) calcination type calcination apparatus, wherein calcination vessels for manufacturing electrode active materials according to claim 1, in the raw material receiving space of each of which raw materials have been received, are introduced into a calcination furnace along a rail in a state in which the calcination vessels are horizontally continuously disposed and at the same time vertically stacked in multiple layers.

23. A calcination vessel assembly comprising:
a plurality of calcination vessels disposed in a 2×2 or more horizontal array on a plane, wherein
each of the calcination vessels comprises:
a base portion forming a bottom surface of the calcination vessel;
side wall portions extending upward from outer peripheries of the base portion to form a raw material receiving space; and
at least two stack support portions extending upward from an upper end of each side wall portion that is not a corner region where adjacent side wall portions abut each other.

24. The calcination vessel assembly according to claim 23, wherein, when the calcination vessels are disposed in a 2×2 horizontal array on a plane, at least six fluid flow paths parallel to the base portions of the calcination vessels, having an angle of 45° to the side wall portions, and parallel to each other are formed.

25. The calcination vessel assembly according to claim 24, wherein the fluid flow paths are provided in 6 to 12.
